(19) United States
(12) Patent Application Publication
(10) Pub. No.: US 2023/0396975 A1
(43) Pub. Date: Dec. 7, 2023

(54) METHOD FOR MMWAVE V2X COMMUNICATION IN MULTIPLE UE COMMUNICATION ENVIRONMENT, AND DEVICE THEREFOR

(71) Applicant: LG ELECTRONICS INC., Seoul (KR)

(72) Inventor: Youngdae KIM, Seoul (KR)

(73) Assignee: LG ELECTRONICS INC., Seoul (KR)

(21) Appl. No.: 18/250,103

(22) PCT Filed: Nov. 1, 2021
(86) PCT No.: PCT/KR2021/015530

§ 371 Date: Apr. 21, 2023

(30) Foreign Application Priority Data
Nov. 3, 2020 (KR) 10-2020-0145369
Nov. 5, 2020 (KR) 10-2020-0146943

(51) Int. Cl. H04W 8/00; H04W 72/1263; H04L 5/00; H04L 1/1812

(52) U.S. Cl. CPC H04W 8/005; H04W 72/1263; H04L 5/0051; H04L 1/1812

(57) ABSTRACT

Provided are a method for mmWAVE vehicle-to-everything (V2X) communication in a multiple user equipment (UE) communication environment, and a device therefor. During a data period, on the basis of having data to be transmitted to a receiving user equipment (UE), a transmitting UE i) transmits, to the receiving UE, a first physical sidelink control channel (PSCCH) for triggering transmission of a beam management reference signal (BRS), ii) transmits the BRS to the receiving UE, iii) transmits, to the receiving UE, a second PSCCH for scheduling the data, and iv) transmits the data to the receiving UE. The transmitting UE receives a measurement result of the BRS from the receiving UE, and adjusts a transmission beam on the basis of the measurement result of the BRS.

### CROSS-REFERENCE TO RELATED APPLICATIONS

This application is the National Stage filing under 35 U.S.C. 371 of International Application No. PCT/KR2021/015530, filed on Nov. 1, 2021, which claims the benefit of earlier filing date and right of priority to Korean Application Nos. 10-2020-0145369, filed on Nov. 3, 2020, and 10-2020-0146943, filed on Nov. 5, 2020, the contents of which are all hereby incorporated by reference herein in their entireties.

### TECHNICAL FIELD

The present disclosure relates to a method for mmWave Vehicle-To-Everything (V2X) communications in a plurality of User Equipments (UEs) communication environments, and apparatus for the same.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

Sidelink (SL) refers to a communication method that establishes a direct link between User Equipments (UE) to directly exchange voice or data between UEs without going through a base station. SL is being considered as a way to solve the burden of base stations due to rapidly increasing data traffic.

Vehicle-To-Everything (V2X) refers to a communication technology that exchanges information with other vehicles, pedestrians, infrastructure objects, etc., through wired and wireless communication. V2X may be categorized into four types: Vehicle-To-Vehicle (V2V), Vehicle-To-Infrastructure (V2I), Vehicle-To-Network (V2N), and/or Vehicle-To-Pedestrian (V2P). V2X communication may be provided through the PCS interface and/or the Uu interface.

### SUMMARY

In the Uu interface (i.e., the interface between the base station and the UE), the control and configuration for beam management is performed by the base station. The UE may measure the reference signal for the resources (time and/or frequency) allocated to it. Upon the UE reporting the results of measurements to the base station, the base station may select and/or adjust the transmission beam for that UE based on the reported information. Alternatively, the UE may select and/or adjust its reception beam based on the received reference signal. However, in a PCS interface (i.e., a direct communication interface between UEs using a sidelink), a particular UE may act as a base station. That is, depending on the relationship between the UEs, a particular UE may configure an RS for beam management and transmit it, and another UE may measure the received RS and report the results. However, in the Uu interface, the UE's connection destination is a single base station, but in the PCS interface, multiple UEs may be connected, which may cause overhead for beam management.

In addition, in communication systems that use beams such as mmWave V2X communications, especially in situations where multiple UEs are connected, if multiple UEs use the same resource pool, the transmitting UE may sense and select a transmission resource to transmit data. However, if the receiving UE does not know when and from which UE the data is being transmitted, it cannot form a beam in that direction at that time, and therefore cannot receive the data. Therefore, the receiving UE needs to know in advance who will transmit the data and when, and the transmitting UE needs to know whether the receiving UE can receive the data at that time. Currently, the transmitting UE may schedule the next transmission through transmission reservation to notify the receiving UE in advance, but when the receiving UE has data to transmit and wants to start the transmission, the same method as traditional transmission reservation cannot be applied.

To address the above problems, according to implementations of the present disclosure, a method in which beam tracking between interconnected UEs is performed over a discovery duration, and beam refinement and/or tracking is performed only when data occurs may be provided. Further, according to implementations of the present disclosure, a method for minimizing RS transmissions and reporting of measurement results thereon using aperiodic and/or semi-persistent reference signal configurations, and for using discovery duration and/or discovery signal to complement may be provided. Further, according to implementations of the present disclosure, a method for maintaining beam alignment or for expediting beam tracking in aperiodic Beam tracking Reference Signal (BRS) transmissions may be provided.

Further, to address the above problems, according to implementations of the present disclosure, a method for a UE to notify its intention to transmit to a counterpart when data to transmit occurs, in order to reserve transmission resources to transmit the data, may be provided.

In an aspect, a method performed by a transmitting User Equipment (UE) in a wireless communication system is provided. The method comprises, based on having data to transmit to a receiving UE, during a data duration: i) transmitting a first Physical Sidelink Control Channel (PSCCH) that triggers transmission of a Beam management Reference Signal (BRS) to the receiving UE; ii) transmitting the BRS to the receiving UE; iii) transmitting a second PSCCH that schedules the data to the receiving UE; and iv) transmitting the data to the receiving UE. The method comprises, receiving a measurement result of the BRS from the receiving UE, and adjusting a transmission beam based on the measurement result of the BRS.

In another aspect, a method performed by a receiving User Equipment (UE) in a wireless communication system is provided. The method comprises, based on having data to receive from a transmitting UE, during a data duration: i) receiving a first Physical Sidelink Control Channel (PSCCH) that triggers transmission of a Beam management Reference Signal (BRS) from the transmitting UE; ii) receiving the BRS from the transmitting UE; iii) receiving a second PSCCH that schedules the data from the transmitting UE; and iv) receiving the data from the transmitting UE. The method comprises transmitting a measurement result of the BRS to the transmitting UE.

In another aspect, apparatuses implementing the above methods are provided.

The present disclosure can have various advantageous effects.

For example, by using aperiodic and/or semi-persistent reference signal configurations as a way of allocating reference signal resources for beam management, and by using discovery signals in a discovery duration to complement this, reference signal transmission and/or measurement result reporting can be minimized.

For example, by first notifying the other party that there is data to be transmitted when it occurs and dynamically allocating resources based on this, resource waste can be reduced.

For example, in mmWave V2X communications, when multiple UEs are connected and each performs beam management, resources can be used efficiently.

For example, the overall overhead of the mmWave V2X communication system can be reduced and the communication efficiency can be increased.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of a wireless device to which implementations of the present disclosure are applied.

FIG. 4 shows an example of UE to which implementations of the present disclosure are applied.

FIGS. 5 and 6 show an example of protocol stacks in a 3GPP based wireless communication system to which implementations of the present disclosure are applied.

FIG. 7 shows a frame structure in a 3GPP based wireless communication system to which implementations of the present disclosure are applied.

FIG. 8 shows an example of beam management at the Uu interface of the 3GPP to which implementations of the present disclosure are applied.

FIG. 9 shows an example of mmWave V2X communication to which implementations of the present disclosure are applied.

FIG. 10 shows an example of BRS transmission in mmWave V2X communication to which implementations of the present disclosure are applied.

FIG. 11 shows an example of a method performed by a transmitting UE to which implementations of the present disclosure are applied.

FIG. 12 shows an example of a method performed by a receiving UE to which implementations of the present disclosure are applied.

FIG. 13 shows an example of a BRS transmission to which the first implementation of the present disclosure is applied.

FIG. 14 shows another example of a BRS transmission to which the first implementation of the present disclosure is applied.

FIG. 15 shows an example where a transmission beam and a reception beam are misaligned to which the first implementation of the present disclosure is applied.

FIG. 16 shows another example of a BRS transmission to which the first implementation of the present disclosure is applied.

FIG. 17 shows an example of transmission beam refinement to which the first implementation of the present disclosure is applied.

FIG. 18 shows an example of resource selection in V2X communications to the second implementation of the present disclosure is applied.

FIG. 19 shows another example of resource selection in V2X communications to the second implementation of the present disclosure is applied.

FIG. 20 shows an example of a method for informing a transmission intention according to the second implementation of the present disclosure.

FIG. 21 shows another example of a method for informing a transmission intention according to the second implementation of the present disclosure.

FIG. 22 shows another example of a method for informing a transmission intention according to the second implementation of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

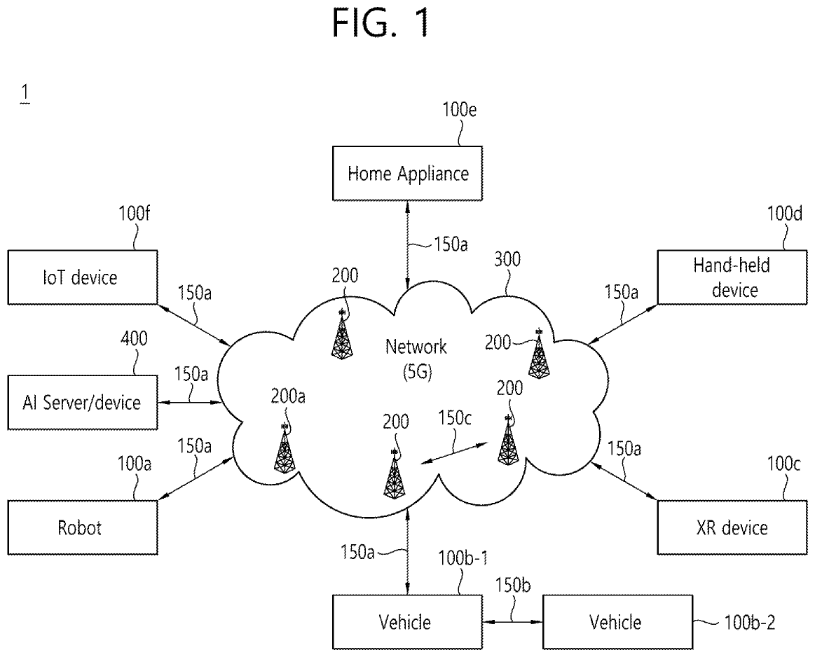

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a Closed-Circuit TV (CCTV), a recorder, or a black box.

The FinTech device may be, for example, a device capable of providing a financial service such as mobile payment. For example, the FinTech device may include a payment device or a Point of Sales (PoS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through Computer Graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities. NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier | |
|---|---|---|---|
| designation | frequency range | Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHz | 60, 120, 240 | kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

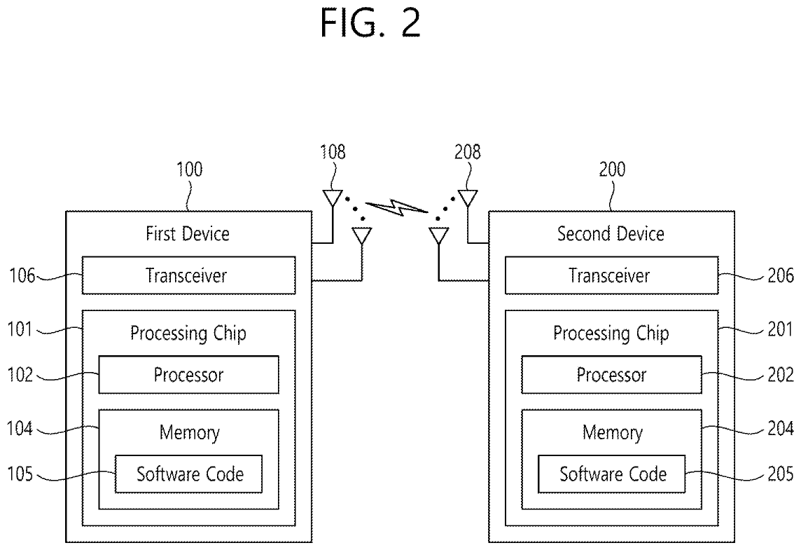

FIG. 2 shows an example of wireless devices to which implementations of the present disclosure are applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs) and/or one or more Service Data Units (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable ROMs (EEPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a Node B (NB), an eNode B (eNB), or a gNB.

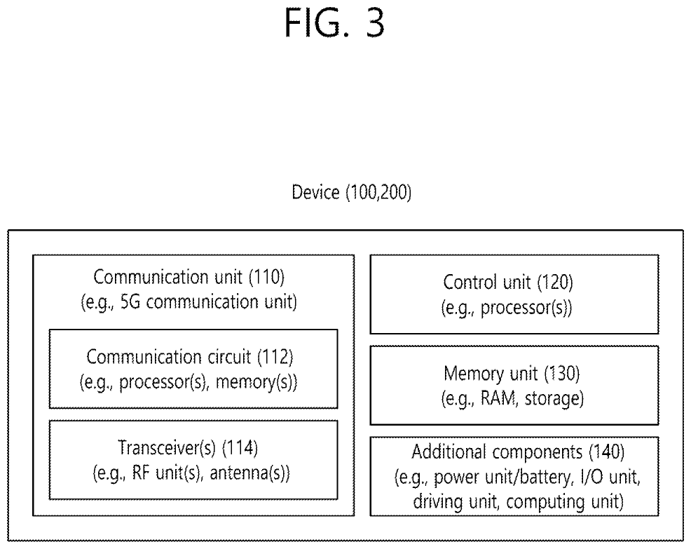

FIG. 3 shows an example of a wireless device to which implementations of the present disclosure are applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, Input/Output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an Application Processor (AP), an Electronic Control Unit (ECU), a Central Processing Unit (CPU), a Graphical Processing Unit (GPU), and a memory control processor. As another example, the memory unit 130 may be configured by a RAM, a Dynamic RAM (DRAM), a ROM, a flash memory, a volatile memory, a non-volatile memory, and/or a combination thereof.

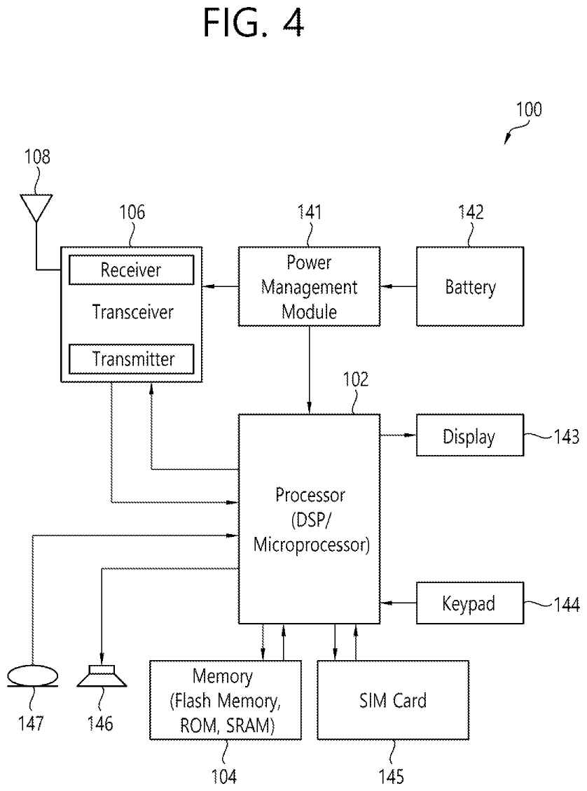

FIG. 4 shows an example of UE to which implementations of the present disclosure are applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

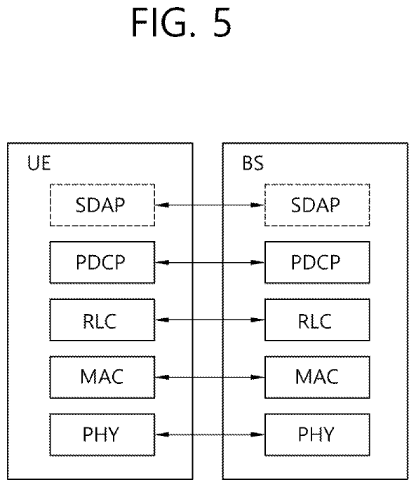

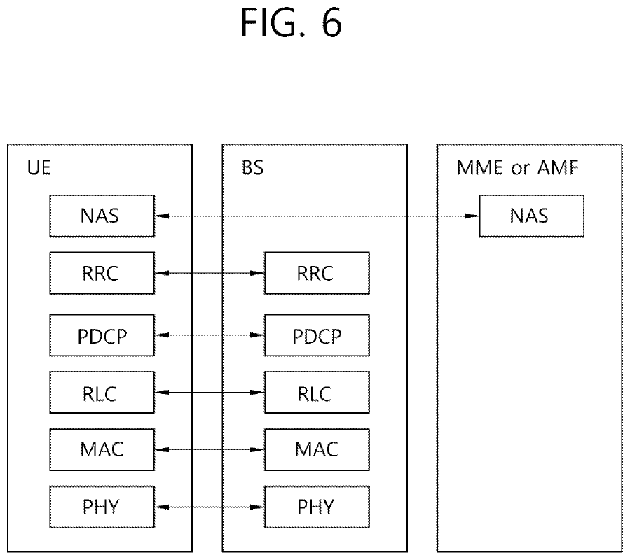

FIGS. 5 and 6 show an example of protocol stacks in a 3GPP based wireless communication system to which implementations of the present disclosure are applied.

In particular, FIG. 5 illustrates an example of a radio interface user plane protocol stack between a UE and a BS and FIG. 6 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 5, the user plane protocol stack may be divided into Layer 1 (i.e., a PHY layer) and Layer 2. Referring to FIG. 6, the control plane protocol stack may be divided into Layer 1 (i.e., a PHY layer), Layer 2, Layer 3 (e.g., an RRC layer), and a Non-Access Stratum (NAS) layer. Layer 1, Layer 2 and Layer 3 are referred to as an Access Stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network Quality of Service (QoS) flows.

In the 3GPP NR system, the main services and functions of the MAC sublayer include: mapping between logical channels and transport channels; multiplexing/de-multiplexing of MAC SDUs belonging to one or different logical channels into/from Transport Blocks (TB) delivered to/from the physical layer on transport channels; scheduling information reporting; error correction through Hybrid Automatic Repeat reQuest (HARQ) (one HARQ entity per cell in case of Carrier Aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast Control Channel (BCCH) is a downlink logical channel for broadcasting system control information, Paging Control Channel (PCCH) is a downlink logical channel that transfers paging information, system information change notifications and indications of ongoing Public Warning Service (PWS) broadcasts, Common Control Channel (CCCH) is a logical channel for transmitting control information between UEs and network and used for UEs having no RRC connection with the network, and Dedicated Control Channel (DCCH) is a point-to-point bi-directional logical channel that transmits dedicated control information between a UE and the network and used by UEs having an RRC connection. Dedicated Traffic Channel (DTCH) is a point-to-point logical channel, dedicated to one UE, for the transfer of user information. A DTCH can exist in both uplink and downlink. In downlink, the following connections between logical channels and transport channels exist: BCCH can be mapped to Broadcast Channel (BCH); BCCH can be mapped to Downlink Shared Channel (DL-SCH); PCCH can be mapped to Paging Channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to Uplink Shared Channel (UL-SCH); DCCH can be mapped to UL-SCH; and DTCH can be mapped to UL-SCH.

The RLC sublayer supports three transmission modes: Transparent Mode (TM), Unacknowledged Mode (UM), and Acknowledged Mode (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using Robust Header Compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS Flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5G Core network (5GC) or Next-Generation Radio Access Network (NG-RAN); establishment, maintenance and release of an RRC connection between the UE and NG-RAN; security functions including key management; establishment, configuration, maintenance and release of Signaling Radio Bearers (SRBs) and Data Radio Bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

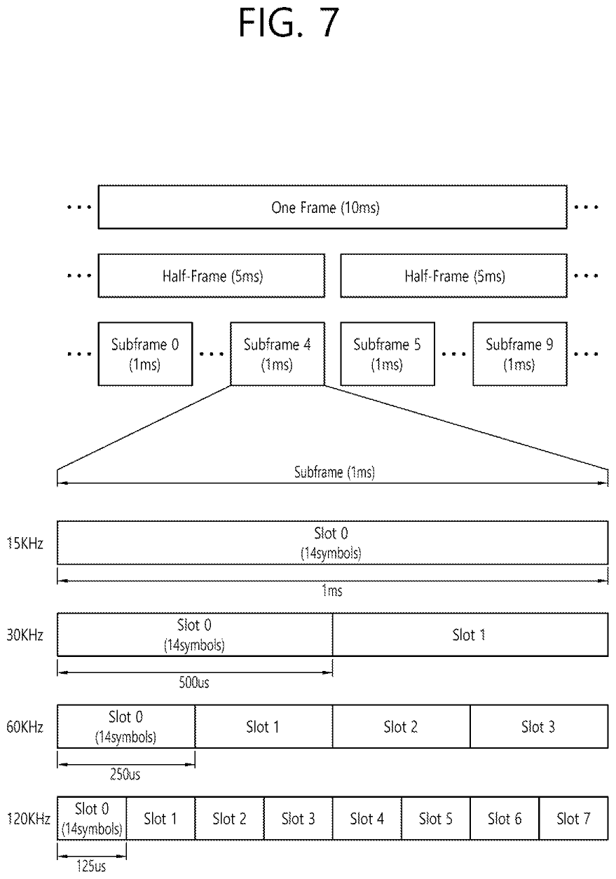

FIG. 7 shows a frame structure in a 3GPP based wireless communication system to which implementations of the present disclosure are applied.

The frame structure shown in FIG. 7 is purely exemplary and the number of subframes, the number of slots, and/or the number of symbols in a frame may be variously changed. In the 3GPP based wireless communication system, OFDM numerologies (e.g., SCS, Transmission Time Interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or Cyclic Prefix (CP)-OFDM symbols), SC-FDMA symbols (or Discrete Fourier Transform-spread-OFDM (DFT-s-OFDM) symbols).

Referring to FIG. 7, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a CP. In a normal CP, each slot includes 14 OFDM symbols and, in an extended CP, each slot includes 12 OFDM symbols. The numerology is based on exponentially scalable subcarrier spacing Δ_{f}=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at Common Resource Block (CRB) N^{start,u}_{grid} indicated by higher-layer signaling (e.g., RRC signaling), where N^{size,u}_{grid,x} is the number of Resource Blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a Resource Element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and Physical Resource Blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a BandWidth Part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB} N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the PHY layer, the uplink transport channels UL-SCH and Random Access Channel (RACH) are mapped to their physical channels Physical Uplink Shared Channel (PUSCH) and Physical Random Access Channel (PRACH), respectively, and the downlink transport channels DL-SCH, BCH and PCH are mapped to Physical Downlink Shared Channel (PDSCH), Physical Broadcast Channel (PBCH) and PDSCH, respectively. In the PHY layer, Uplink Control Information (UCI) is mapped to PUCCH, and Downlink Control Information (DCI) is mapped to Physical Downlink Control Channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, Vehicle-To-Everything (V2X) communications and/or Sidelink (SL) communications are described.

For example, the UE1 may select a resource unit corresponding to a particular resource within a resource pool, which is a set of resources. The UE1 may then transmit an SL signal using the resource unit. For example, the UE2, the receiving UE, may be configured with a resource pool over which the UE1 may transmit the signal, and may detect the signal of UE1 within the resource pool.

Here, if the UE1 is within the connectivity range of the base station, the base station may inform the UE1 of the resource pool. On the other hand, if the UE1 is out of the connectivity range of the base station, another UE may inform the UE1 of the resource pool, or the UE1 may use a preconfigured resource pool.

In general, a resource pool may consist of a plurality of resource units, and each UE may select one or more resource units to use for its SL signal transmission.

A resource unit may appear periodically and repeatedly. Alternatively, the index of the physical resource unit to which one logical resource unit is mapped may vary over time in a predetermined pattern, in order to achieve a diversity effect in the time or frequency domain. In terms of the structure of these resource units, a resource pool may refer to a set of resource units that are available for transmission by a UE that wishes to transmit SL signaling.

Hereinafter, resource allocation in SL is described.

A UE may perform V2X communication and/or SL communication depending on the transmission mode. The transmission mode may be referred to as a mode and/or a resource allocation mode. The transmission mode in an LTE system may be referred to as an LTE transmission mode, and the transmission mode in an NR system may be referred to as an NR resource allocation mode. LTE transmission mode 1/2 may be applied to general SL communication, and LTE transmission mode 3/4 may be applied to V2X communication.

In LTE transmission mode 1, LTE transmission mode 3, and/or NR resource allocation mode 1, the base station may schedule the SL resources to be used by the UEs for SL transmission. For example, the base station may perform resource scheduling by transmitting a DCI via PDCCH to UE1, and UE1 may perform V2X communication and/or SL communication with UE2 based on the resource scheduling. For example, UE1 may transmit Sidelink Control Information (SCI) to UE2 via a Physical Sidelink Control Channel (PSCCH), and then transmit data based on the SCI to UE2 via a Physical Sidelink Shared Channel (PSSCH).

For example, in NR resource allocation mode 1, the UE may be provided and/or allocated resources for one or more SL transmissions of one TB by the base station via dynamic grant. For example, the base station may provide resources to the UE for the transmission of PSCCH and/or PSSCH using dynamic grant. For example, the transmitting UE may report to the base station the SL HARQ feedback received from the receiving UE. In this case, the PUCCH resources and timing for reporting the SL HARQ feedback to the base station may be determined based on the instructions in the PDCCH for the base station to allocate resources for SL transmission.

For example, in NR resource allocation mode 1, the UE may periodically be provided and/or allocated a set of resources for a plurality of SL transmissions by the base station via a configured grant. For example, the configured grant may include a configured grant type 1 or a configured grant type 2. For example, the UE may determine the TB to be transmitted at each of the occasions indicated by a given configured grant.

In LTE transmission mode 2, LTE transmission mode 4, and/or NR resource allocation mode 2, the UE may determine the SL transmission resource within the SL resource configured by the base station/network and/or the preconfigured SL resource. For example, the configured SL resource and/or the preconfigured SL resource may be a resource pool. For example, the UE may autonomously select or schedule resources for SL transmission. For example, the UE may autonomously select a resource within the configured resource pool to perform V2X communication and/or SL communication. For example, the UE may perform a sensing and resource (re)selection procedure to autonomously select a resource within a selection window. For example, the sensing may be performed on a subchannel unit. Then, upon autonomously selecting a resource within the resource pool, UE1 may transmit a SCI to UE2 via PSCCH, and then transmit data based on the SCI to UE2 via PSSCH.

Hereinafter, SL measurement and reporting are described.

SL measurement and reporting between UEs may be considered in SL for purposes such as QoS prediction, initial transmission parameter setting, link adaptation, link management, admission control, etc. For example, a receiving UE may receive a reference signal from a transmitting UE, and the receiving UE may measure a channel state (e.g., Reference Signal Received Power (RSRP) and/or Reference Signal Received Quality (RSRQ)) for the transmitting UE based on the reference signal. The receiving UE may then report Channel State Information (CSI) to the transmitting UE. SL-related measurement and reporting may include measurement and reporting of Channel Busy Ratio (CBR) and/or reporting of location information. Examples of CSIs for V2X communications may include Channel Quality Indicator (CQI), Precoding Matrix Index (PMI), Rank Indicator (RI), RSRP, RSRQ, pathgain/pathloss, Sounding Reference Symbols (SRS) Resource Indicator (SRI), CSI-RS Resource Indicator (CRI), interference condition, vehicle motion, etc. For unicast communications, CQI, RI, and PMI, or some of them, may be supported in a non-subband-based aperiodic CSI reporting assuming four or fewer antenna ports. The CSI procedure may not rely on a standalone reference signal. CSI reporting may be enabled and disabled based on configurations.

For example, a transmitting UE may transmit a CSI-RS to a receiving UE, and the receiving UE may utilize the CSI-RS to measure CQI and/or RI. For example, the CSI-RS may be referred to as a SL CSI-RS. For example, said CSI-RS may be confined within a PSSCH transmission. For example, the transmitting UE may include the CSI-RS in the PSSCH resource and transmit it to the receiving UE.

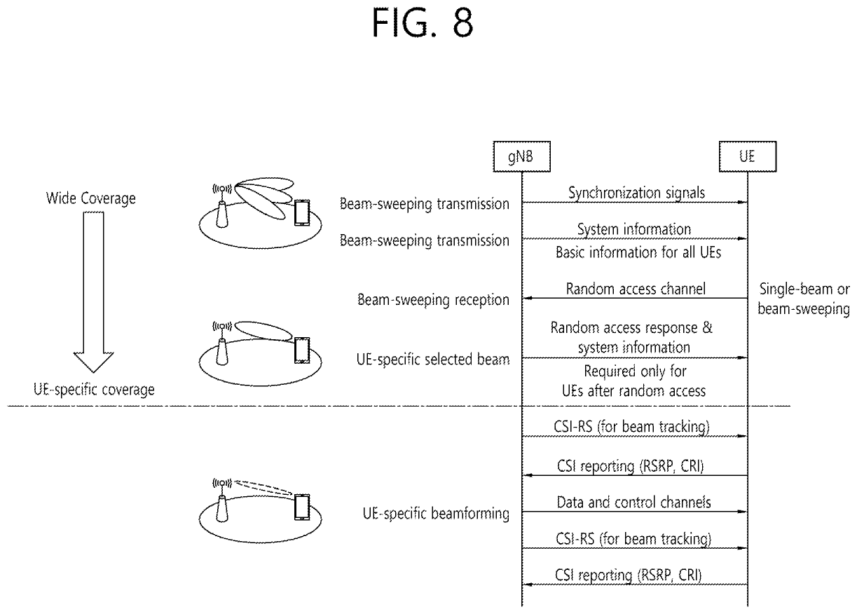

FIG. 8 shows an example of beam management at the Uu interface of the 3GPP to which implementations of the present disclosure are applied.

Referring to FIG. 8, beam management at the Uu interface of the 3GPP may proceed from beam management for broad coverage to beam management for UE specific coverage. Specifically, beam management at the Uu interface of 3GPP may be accomplished through the following process.
First, the base station transmits system information, including synchronization signals and basic information for all UEs, to a plurality of UEs via a beam sweeping transmission. Upon receiving this, the UEs transmit a random access signal (e.g., random access preamble) to the base station via single beam transmission and/or beam sweeping transmission. The base station receives the random access signal via beam sweeping reception.
The base station transmits a random access response and/or system information to the UE in response to the random access signal over a UE-specific selected beam.
The base station transmits a CSI-RS to the UE for beam tracking. The UE measures the received CSI-RS and transmits the CSI reporting which is a result of the measurements to the base station. The CSI reporting may include RSRP and/or CRI. Based on the received CSI reporting, the base station may further refine the transmission beam for that UE, resulting in a more efficient UE-specific beamforming transmission. Alternatively, the UE may adjust the UE's reception beam based on the received CSI-RS.

In mmWave V2X communication, when a UE establishes a connection with multiple UEs, it is necessary to allocate resources for beam management and corresponding reference signals for each UE. Hereinafter, an RS for beam management in mmWave V2X communication is referred to as a Beam tracking Reference Signal (BRS).

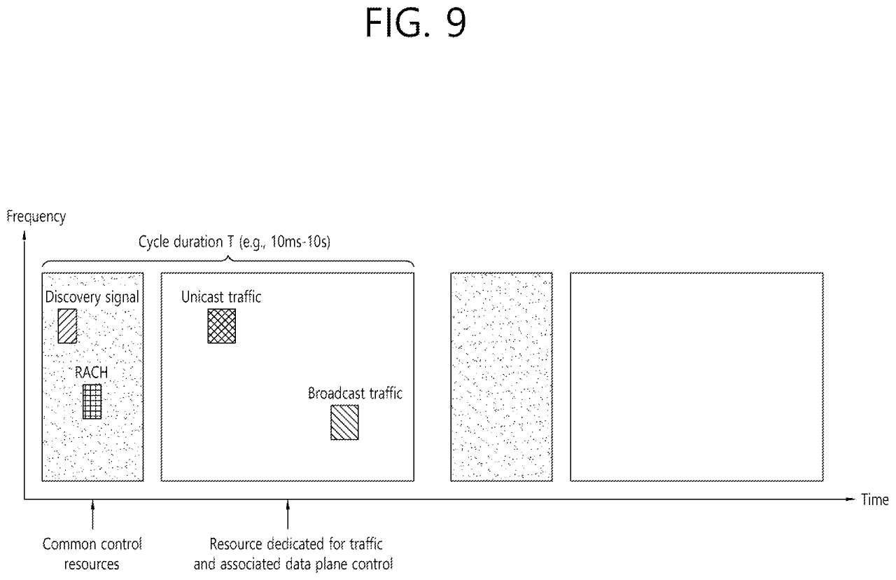

FIG. 9 shows an example of mmWave V2X communication to which implementations of the present disclosure are applied.

Referring to FIG. 9, mmWave V2X communication may be performed according to a periodic duration T (e.g., 10 ms-10 s), and the periodic duration T may be divided into a discovery duration and a data transmission duration. Detection of other UEs and/or initial beam acquisition may be performed in the discovery duration. That is, beam alignment may be required first for detection of other UEs and/or connection establishment, and a discovery process including these actions may be performed periodically in the discovery duration.

After the UEs are connected to each other and the initial beam acquisition is performed, the beam refinement and/or beam tracking process may be performed continuously in the data transmission duration. Accordingly, the transmitting UE may transmit a BRS. The BRS may be transmitted in the data transmission duration. The receiving UE may receive the BRS, measure it, and report the measurement results to the transmitting UE. The transmitting UE may select the best transmission beam (e.g., transmission beam refinement and/or tracking) based on the received measurement results. Alternatively, the receiving UE may select the best reception beam (e.g., reception beam refinement and/or tracking) by measuring the received BRS while changing its reception beam.

Meanwhile, since the discovery process is performed periodically through the discovery duration, UEs that have already established a connection may also periodically know whether the beam alignment between the transmitting UE and the receiving UE is achieved through the transmission and reception of discovery signals.

When communication and beam management is performed between UEs as described in FIG. 9, as the number of UEs connected to a single UE increases, the overhead for beam management may increase and scheduling may become more complex. For example, as the number of connected UEs increases, the number of BRSs increases, which may reduce the resources for data that can be allocated to each UE. In addition, since two connected UEs may also have connection with other different UEs, the BRS configured by one UE may conflict with the BRS of another UE. This is always a problem unless there is centralized control, such as control by a base station.

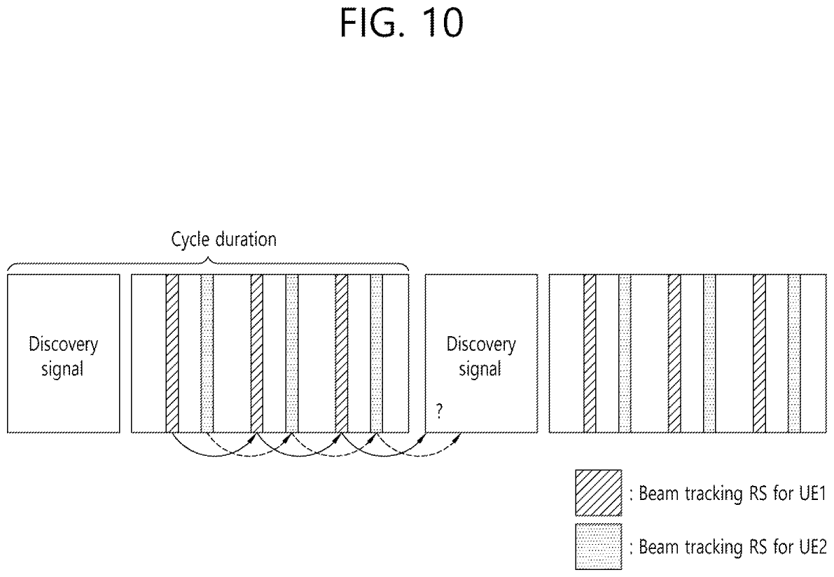

FIG. 10 shows an example of BRS transmission in mmWave V2X communication to which implementations of the present disclosure are applied.

The BRS transmission may include a periodic BRS transmission and an aperiodic BRS transmission. Periodic BRS transmission is the transmission of BRS for continuous beam tracking, which may be similar to a periodic CSI-RS configuration. Aperiodic BRS transmission is the transmission of BRS only when needed, which may be similar to aperiodic CSI-RS and/or semi-persistent CSI-RS configuration. Depending on the type of data transferred by the service, either periodic or aperiodic BRS transmission may be selected. That is, if data occurs periodically, periodic BRS transmission may be more appropriate. On the other hand, if data occurs in bursts, aperiodic BRS transmission, where BRS is transmitted only when data occurs and/or when an event occurs, or periodic BRS transmission only during the actual data transmission duration, may be more appropriate.

Referring now to FIG. 10, an example of assigning and/or transmitting a BRS for each UE is shown where a UE is associated with two other UEs. FIG. 10 shows an example of periodic BRS transmission, which may have the following problems.
As the number of connected UEs increases, the overhead of BRS transmission and/or measurement/reporting may also increase, resulting in a decrease in data transmission resources.
Unless the base station or one UE controls the entire BRS transmission, the BRS configuration of one UE may conflict with the BRS configuration and/or data transmission configuration of other UEs. This may increase the complexity of scheduling and/or configuration. For example, additions/changes to the BRS configuration and/or data transmission configuration of a particular UE may cascade to require changes to the configurations of other UEs.
Since the discovery duration is a common resource duration, it is not possible to allocate a dedicated BRS for a specific UE.

Therefore, if each UE is performing beam management control independently and not under the control of the base station, the transmission of BRS and the reporting of its measurement results needs to be minimized. In order to minimize the transmission of BRS, it may be desirable to transmit BRS aperiodically and only when necessary, rather than periodically. However, in order to transmit the BRS, the transmission beam of the transmitting UE and the reception beam of the receiving UE need to be aligned with each other.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

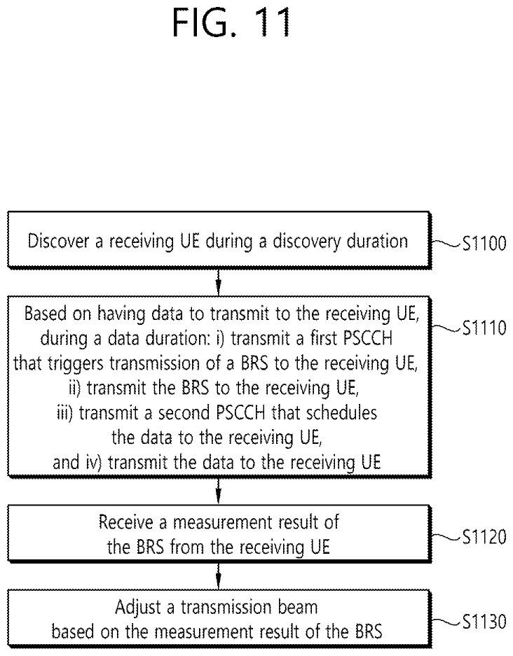

FIG. 11 shows an example of a method performed by a transmitting UE to which implementations of the present disclosure are applied.

In step S1100, the method comprises discovering a receiving UE during a discovery duration.

In step S1110, the method comprises, based on having data to transmit to the receiving UE, during a data duration: i) transmitting a first PSCCH that triggers transmission of a BRS to the receiving UE; ii) transmitting the BRS to the receiving UE; iii) transmitting a second PSCCH that schedules the data to the receiving UE; and iv) transmitting the data to the receiving UE.

In other words, in order to reduce the complexity of beam refinement and/or tracking during the discovery process, the transmission of the BRS may be triggered via PSCCH before the data transmission in the data transmission duration.

In some implementations, the BRS may be transmitted aperiodically. This means that the BRS may not be transmitted periodically.

In some implementations, the transmission of the BRS may be triggered according to a difference between the time of beam refinement and/or tracking in the discovery process and the actual transmission time of the data. Alternatively, it may be indicated via PSCCH so that data can be transmitted immediately.

In some implementations, the method may further comprise, during the discovery duration: i) transmitting a discovery signal for discovery of another UE to the receiving UE, and ii) receiving a response message for which the discovery signal is measured and reported from the receiving UE.

For example, when the receiving UE detects a plurality of transmission beams, the response message may include an index and a measurement result of a beam having a best measurement result among the plurality of transmission beams. In this case, the response message may be received using a resource corresponding to the beam having the best measurement result.

For example, when the receiving UE detects a plurality of transmission beams, the response message may include an index and a measurement result for each of the plurality of transmission beams. In this case, the response message may be received separately using a resource associated with each of the plurality of transmission beams.

In some implementations, the response message may be received via a preconfigured and/or a preassigned frequency resource. The preconfigured and/or the preassigned frequency resource may not conflict with a frequency resource used by another UE for the response message during a discovery process.

In some implementations, the response message may comprise at least one of a response type (e.g., if no dedicated resources are allocated for the response messages), a UE Identifier (ID), and/or a status of the receiving UE (e.g., location, velocity, and/or variation of the receiving UE).

In some implementations, based on the status of the UE received via the response message, whether to transmit an additional message to the receiving UE may be determined. For example, if the status of the UE has not changed significantly, the transmitting UE may not trigger the transmission of an additional message and BRS transmission in the data transmission duration, and may transmit and receive data over the previously aligned transmission beam with the receiving UE. For example, if the status of the UE has changed, the transmitting UE may transmit to the receiving UE an additional message for reception beam tracking and/or transmission beam refinement in response to the response message. The additional message may be transmitted repeatedly. The purpose and/or number of the repeated transmissions may be predetermined directly and/or indirectly via beam related information exchanged between the transmitting UE and the receiving UE. In the case of repeated transmission of the additional message for transmission beam refinement, the candidate transmission beam on which the additional message may be transmitted may be selected based on an index and strength of the signal of a reception beam on which the response message is received.

In step S1120, the method comprises receiving a measurement result of the BRS from the receiving UE.

In step S1130, the method comprises adjusting a transmission beam based on the measurement result of the BRS.

In some implementations, the method may further comprise receiving information informing presence or absence of an intention to transmit data from the receiving UE.

In some implementations, the information informing presence or absence of the intention to transmit data may be received in conjunction with a HARQ-ACK for the data and/or may be received subsequent to reception of the HARQ-ACK.

For example, when the information informing presence or absence of the intention to transmit data is received in conjunction with the HARQ-ACK, the information informing presence or absence of the intention to transmit data may be received on the PSFCH via a 1 bit. Therefore, multiple PSFCHs may be received. In this case, a frequency resource for the information informing presence or absence of the intention to transmit data may be associated with a frequency resource for the HARQ-ACK (e.g., a fixed offset is applied to the frequency resource for the HARQ-ACK). Alternatively, a dedicated resource may be allocated for the PSFCH on which the information informing presence or absence of the intention to transmit data is received.

For example, when the information informing presence or absence of the intention to transmit data is received in conjunction with the HARQ-ACK, a new PSFCH may be designed that can carry the HARQ-ACK together with the information informing presence or absence of the intention to transmit data via 2 bits.

In some implementations, the information informing presence or absence of the intention to transmit data may be received by being included in a response message to a discovery signal in the discovery duration. In this case, the ID of the receiving UE may be included together. Upon receiving the intention to transmit data of the receiving UE, the transmitting UE may allocate transmission resources for the receiving UE at the next data transmission time.

In some implementations, the information informing presence or absence of the intention to transmit data may be received periodically. For example, the information informing presence or absence of the intention to transmit data may be transmitted by both the transmitting UE and the receiving UE. For example, the information informing presence or absence of the intention to transmit data may be transmitted only by the receiving UE. For example, the information informing presence or absence of the intention to transmit data may comprise 1-2 symbols, and/or may reuse the PSFCH structure. For example, the information informing presence or absence of the intention to transmit data may comprise a reference signal, which may be assigned to different frequencies depending on the presence or absence of transmission. If the information informing presence or absence of the intention to transmit data is composed of a reference signal, as the transmitting UE and the receiving UE may know when the reference signal will be transmitted, the corresponding reference signal may be used for beam failure recovery and/or beam tracking.

In some implementations, the transmitting UE may be in communication with at least one of a mobile device, a network, and/or autonomous vehicles other than the transmitting UE.

Furthermore, the method in perspective of the transmitting UE described above in FIG. 11 may be performed by the first wireless device 100 shown in FIG. 2, the wireless device 100 shown in FIG. 3, and/or the UE 100 shown in FIG. 4.

More specifically, the transmitting UE comprises at least one transceiver, at least one processor, and at least one memory operably connectable to the at least one processor. The at least one memory stores instructions that, based on being executed by the at least one processor, perform operations below.

The transmitting UE discovers a receiving UE during a discovery duration.

The transmitting UE, based on having data to transmit to the receiving UE, during a data duration using the at least one transceiver: i) transmits a first PSCCH that triggers transmission of a BRS to the receiving UE; ii) transmits the BRS to the receiving UE; iii) transmits a second PSCCH that schedules the data to the receiving UE; and iv) transmits the data to the receiving UE.

In other words, in order to reduce the complexity of beam refinement and/or tracking during the discovery process, the transmission of the BRS may be triggered via PSCCH before the data transmission in the data transmission duration.

In some implementations, the BRS may be transmitted aperiodically. This means that the BRS may not be transmitted periodically.

In some implementations, the transmission of the BRS may be triggered according to a difference between the time of beam refinement and/or tracking in the discovery process and the actual transmission time of the data. Alternatively, it may be indicated via PSCCH so that data can be transmitted immediately.

In some implementations, the transmitting UE may, during the discovery duration using the at least one transceiver: i) transmit a discovery signal for discovery of another UE to the receiving UE, and ii) receive a response message for which the discovery signal is measured and reported from the receiving UE.

For example, when the receiving UE detects a plurality of transmission beams, the response message may include an index and a measurement result of a beam having a best measurement result among the plurality of transmission beams. In this case, the response message may be received using a resource corresponding to the beam having the best measurement result.

For example, when the receiving UE detects a plurality of transmission beams, the response message may include an index and a measurement result for each of the plurality of transmission beams. In this case, the response message may be received separately using a resource associated with each of the plurality of transmission beams.

In some implementations, the response message may be received via a preconfigured and/or a preassigned frequency resource. The preconfigured and/or the preassigned frequency resource may not conflict with a frequency resource used by another UE for the response message during a discovery process.

In some implementations, the response message may comprise at least one of a response type (e.g., if no dedicated resources are allocated for the response messages), a UE Identifier (ID), and/or a status of the receiving UE (e.g., location, velocity, and/or variation of the receiving UE).

In some implementations, based on the status of the UE received via the response message, whether to transmit an additional message to the receiving UE may be determined. For example, if the status of the UE has not changed significantly, the transmitting UE may not trigger the transmission of an additional message and BRS transmission in the data transmission duration, and may transmit and receive data over the previously aligned transmission beam with the receiving UE. For example, if the status of the UE has changed, the transmitting UE may transmit to the receiving UE an additional message for reception beam tracking and/or transmission beam refinement in response to the response message. The additional message may be transmitted repeatedly. The purpose and/or number of the repeated transmissions may be predetermined directly and/or indirectly via beam related information exchanged between the transmitting UE and the receiving UE. In the case of repeated transmission of the additional message for transmission beam refinement, the candidate transmission beam on which the additional message may be transmitted may be selected based on an index and strength of the signal of a reception beam on which the response message is received.

The transmitting UE receives a measurement result of the BRS from the receiving UE using the at least one transceiver.

The transmitting UE adjusts a transmission beam of the at least one transceiver based on the measurement result of the BRS.

In some implementations, the transmitting UE may receive information informing presence or absence of an intention to transmit data from the receiving UE.

In some implementations, the information informing presence or absence of the intention to transmit data may be received in conjunction with a HARQ-ACK for the data and/or may be received subsequent to reception of the HARQ-ACK.

For example, when the information informing presence or absence of the intention to transmit data is received in conjunction with the HARQ-ACK, the information informing presence or absence of the intention to transmit data may be received on the PSFCH via a 1 bit. Therefore, multiple PSFCHs may be received. In this case, a frequency resource for the information informing presence or absence of the intention to transmit data may be associated with a frequency resource for the HARQ-ACK (e.g., a fixed offset is applied to the frequency resource for the HARQ-ACK). Alternatively, a dedicated resource may be allocated for the PSFCH on which the information informing presence or absence of the intention to transmit data is received.

For example, when the information informing presence or absence of the intention to transmit data is received in conjunction with the HARQ-ACK, a new PSFCH may be designed that can carry the HARQ-ACK together with the information informing presence or absence of the intention to transmit data via 2 bits.

In some implementations, the information informing presence or absence of the intention to transmit data may be received by being included in a response message to a discovery signal in the discovery duration. In this case, the ID of the receiving UE may be included together. Upon receiving the intention to transmit data of the receiving UE, the transmitting UE may allocate transmission resources for the receiving UE at the next data transmission time.

In some implementations, the information informing presence or absence of the intention to transmit data may be received periodically. For example, the information informing presence or absence of the intention to transmit data may be transmitted by both the transmitting UE and the receiving UE. For example, the information informing presence or absence of the intention to transmit data may be transmitted only by the receiving UE. For example, the information informing presence or absence of the intention to transmit data may comprise 1-2 symbols, and/or may reuse the PSFCH structure. For example, the information informing presence or absence of the intention to transmit data may comprise a reference signal, which may be assigned to different frequencies depending on the presence or absence of transmission. If the information informing presence or absence of the intention to transmit data is composed of a reference signal, as the transmitting UE and the receiving UE may know when the reference signal will be transmitted, the corresponding reference signal may be used for beam failure recovery and/or beam tracking.

Furthermore, the method in perspective of the transmitting UE described above in FIG. 11 may be performed by control of the processor 102 included in the first wireless device 100 shown in FIG. 2, by control of the communication unit 110 and/or the control unit 120 included in the wireless device 100 shown in FIG. 3, and/or by control of the processor 102 included in the UE 100 shown in FIG. 4.

More specifically, a processing apparatus operating in a wireless communication system comprises at least one processor, and at least one memory operably connectable to the at least one processor. The at least one processor is adapted to perform operations comprising: based on having data to transmit, during a data duration: i) generating a first PSCCH that triggers transmission of a BRS, and ii) generating the BRS, obtaining a measurement result of the BRS, and adjusting a transmission beam based on the measurement result of the BRS.

Furthermore, the method in perspective of the transmitting UE described above in FIG. 11 may be performed by a software code 105 stored in the memory 104 included in the first wireless device 100 shown in FIG. 2.

The technical features of the present disclosure may be embodied directly in hardware, in a software executed by a processor, or in a combination of the two. For example, a method performed by a wireless device in a wireless communication may be implemented in hardware, software, firmware, or any combination thereof. For example, a software may reside in RAM, flash memory, ROM, EPROM, EEPROM, registers, hard disk, a removable disk, a CD-ROM, or any other storage medium.

Some example of storage medium may be coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include RAM such as synchronous dynamic random access memory (SDRAM), ROM, non-volatile random access memory (NVRAM), EEPROM, flash memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some implementations of the present disclosure, a non-transitory computer-readable medium (CRM) has stored thereon a plurality of instructions.

More specifically, at least one CRM stores instructions that, based on being executed by at least one processor, perform operations comprising: based on having data to transmit, during a data duration: i) generating a first PSCCH that triggers transmission of a BRS, and ii) generating the BRS, obtaining a measurement result of the BRS, and adjusting a transmission beam based on the measurement result of the BRS.

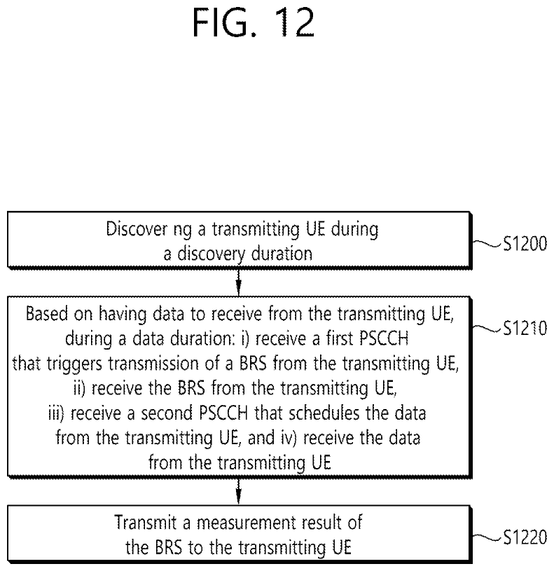

FIG. 12 shows an example of a method performed by a receiving UE to which implementations of the present disclosure are applied.

In step S1200, the method comprises discovering a transmitting UE during a discovery duration.

In step S1210, the method comprises, based on having data to receive from the transmitting UE, during a data duration: i) receiving a first PSCCH that triggers transmission of a BRS from the transmitting UE, ii) receiving the BRS from the transmitting UE, iii) receiving a second PSCCH that schedules the data from the transmitting UE, and iv) receiving the data from the transmitting UE.

In some implementations, the method may further comprise, during the discovery duration: i) receiving a discovery signal for discovery of another UE from the transmitting UE, and ii) transmitting a response message for which the discovery signal is measured and reported to the transmitting UE.

For example, when the receiving UE detects a plurality of transmission beams, the response message may include an index and a measurement result of a beam having a best measurement result among the plurality of transmission beams. In this case, the response message may be transmitted using a resource corresponding to the beam having the best measurement result.

For example, when the receiving UE detects a plurality of transmission beams, the response message may include an index and a measurement result for each of the plurality of transmission beams. In this case, the response message may be transmitted separately using a resource associated with each of the plurality of transmission beams.

In some implementations, the response message may be transmitted via a preconfigured and/or a preassigned frequency resource. The preconfigured and/or the preassigned frequency resource may not conflict with a frequency resource used by another UE for the response message during a discovery process.

In some implementations, the response message may comprise at least one of a response type (e.g., if no dedicated resources are allocated for the response messages), a UE ID, and/or a status of the receiving UE (e.g., location, velocity, and/or variation of the receiving UE).

In step S1220, the method comprises transmitting a measurement result of the BRS to the transmitting UE.

Furthermore, the method in perspective of the receiving UE described above in FIG. 12 may be performed by the second wireless device 200 shown in FIG. 2, the wireless device 100 shown in FIG. 3, and/or the UE 100 shown in FIG. 4.

More specifically, the receiving UE comprises at least one transceiver, at least one processor, and at least one memory operably connectable to the at least one processor. The at least one memory stores instructions that, based on being executed by the at least one processor, perform operations below.

The receiving UE discovers a transmitting UE during a discovery duration.

The receiving UE, based on having data to receive from the transmitting UE, during a data duration using the at least one transceiver: i) receives a first PSCCH that triggers transmission of a BRS from the transmitting UE, ii) receives the BRS from the transmitting UE, iii) receives a second PSCCH that schedules the data from the transmitting UE, and iv) receives the data from the transmitting UE.

In some implementations, the receiving UE may further, during the discovery duration using the at least one transceiver: i) receive a discovery signal for discovery of another UE from the transmitting UE, and ii) transmit a response message for which the discovery signal is measured and reported to the transmitting UE.

For example, when the receiving UE detects a plurality of transmission beams, the response message may include an index and a measurement result of a beam having a best measurement result among the plurality of transmission beams. In this case, the response message may be transmitted using a resource corresponding to the beam having the best measurement result.

For example, when the receiving UE detects a plurality of transmission beams, the response message may include an index and a measurement result for each of the plurality of transmission beams. In this case, the response message may be transmitted separately using a resource associated with each of the plurality of transmission beams.

In some implementations, the response message may be transmitted via a preconfigured and/or a preassigned frequency resource. The preconfigured and/or the preassigned frequency resource may not conflict with a frequency resource used by another UE for the response message during a discovery process.

In some implementations, the response message may comprise at least one of a response type (e.g., if no dedicated resources are allocated for the response messages), a UE ID, and/or a status of the receiving UE (e.g., location, velocity, and/or variation of the receiving UE).

The receiving UE transmits a measurement result of the BRS to the transmitting UE using the at least one transceiver.

Furthermore, the method in perspective of the receiving UE described above in FIG. 12 may be performed by control of the processor 202 included in the second wireless device 200 shown in FIG. 2, by control of the communication unit 110 and/or the control unit 120 included in the wireless device 100 shown in FIG. 3, and/or by control of the processor 102 included in the UE 100 shown in FIG. 4.

More specifically, a processing apparatus operating in a wireless communication system comprises at least one processor, and at least one memory operably connectable to the at least one processor. The at least one processor is adapted to perform operations comprising: based on having data to receive, during a data duration: i) obtaining a first PSCCH that triggers transmission of a BRS, ii) obtaining the BRS, and generating a measurement result of the BRS.

Furthermore, the method in perspective of the receiving UE described above in FIG. 12 may be performed by a software code 205 stored in the memory 204 included in the second wireless device 200 shown in FIG. 2.

More specifically, at least one CRM stores instructions that, based on being executed by at least one processor, perform operations comprising: based on having data to receive, during a data duration: i) obtaining a first PSCCH that triggers transmission of a BRS, ii) obtaining the BRS, and generating a measurement result of the BRS.

Hereinafter, various implementations of the present disclosure are described.

### 1. First Implementation

According to the first implementation of the present disclosure, when each UE is managing resources for beam management in an environment where a plurality of UEs performing mmWave V2X communications is connected, a method for minimizing the transmission of a reference signal (e.g., BRS) for beam refinement and/or tracking in a data transmission duration between each UE, and using a discovery duration to complement may be provided.

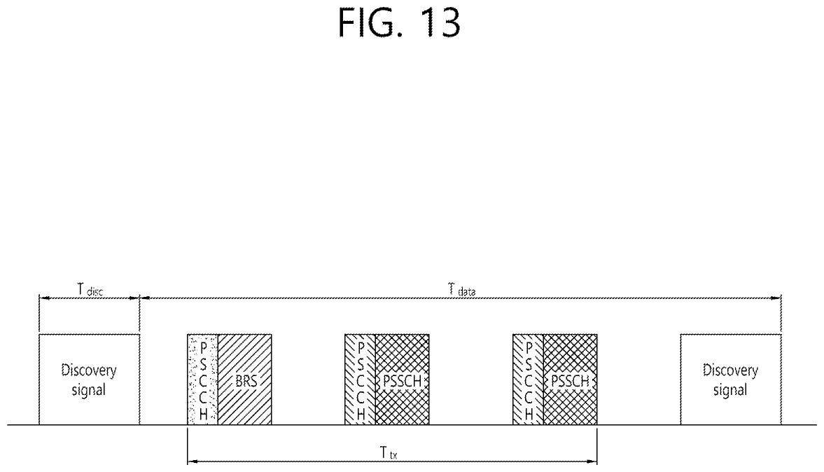

FIG. 13 shows an example of a BRS transmission to which the first implementation of the present disclosure is applied.

Referring to FIG. 13, the BRS may not be transmitted periodically, and the BRS transmission may be triggered only when there is data to be transmitted. Additionally, the discovery process in the discovery duration may be used to complment the BRS transmission.

More specifically, if there is data to be transmitted in the data transmission duration, the transmitting UE first triggers and/or schedules the transmission of a aperiodic BRS for beam refinement and/or tracking via PSCCH. The transmitting UE may transmit the BRS triggered and/or scheduled by the PSCCH via PSSCH instead of data. The receiving UE may measure the received BRS to adjust its reception beam, and/or report the measurement results to the transmitting UE so that the transmitting UE can adjust its transmission beam.

Although FIG. 13 exemplarily shows the transmission of an aperiodic BRS, the transmitting UE may trigger and/or schedule the transmission of a semi-persistent BRS via the PSCCH. That is, the transmitting UE may trigger and/or schedule the transmission of a semi-persistent BRS such that the semi-persistent BRS can be transmitted during a time where data transmission is expected (e.g., Tₜₓ in FIG. 13) and/or during a data transmission duration (e.g., T_{data} in FIG. 13).

Meanwhile, for example, if the beam used for transmission of the discovery signal and the beam used for transmission of the data have the same width and/or if the vehicle is stopped due to, e.g., at a traffic light, so that beam refinement and/or tracking is not required, the transmitting UE may transmit the data directly without triggering and/or scheduling the transmission of the BRS.

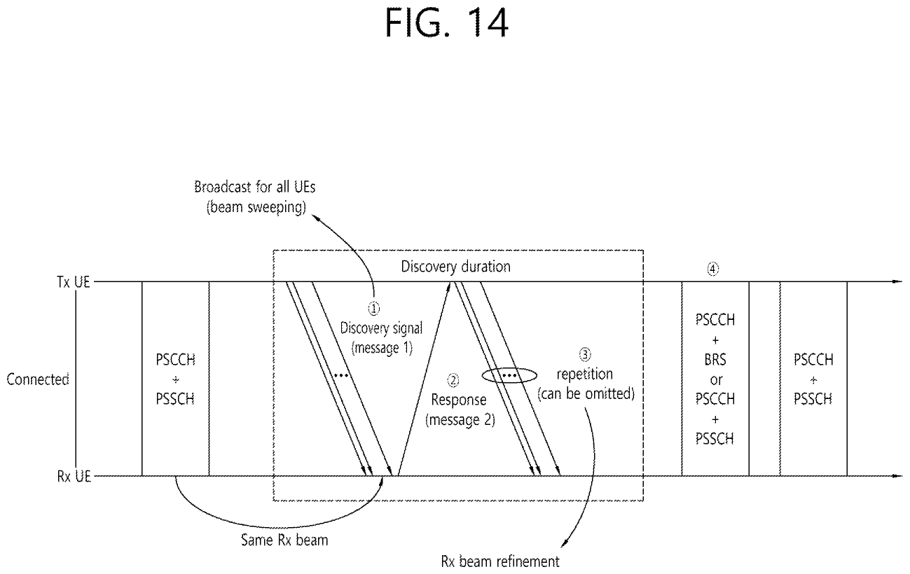

FIG. 14 shows another example of a BRS transmission to which the first implementation of the present disclosure is applied.

FIG. 14 shows beam management for a case where the beam used for transmission of the discovery signal and the beam used for transmission of the data have the same width. The operations of the transmitting UE and the receiving UE shown in FIG. 14 are as follows.

1. The transmitting UE transmits the discovery signal (or message 1) in the discovery duration in all directions by beam sweeping transmission. The receiving UE measures the discovery signal transmitted by the transmitting UE over the reception beam used to receive the data transmitted by the transmitting UE. The receiving UE may perform the measurement on all the transmission beams on which the discovery signal is transmitted. Alternatively, the receiving UE may perform the measurement only on the transmission beam that are associated (e.g., in a Quasi-Co-Located (QCL) relationship) with the data transmission among all the transmission beams on which the discovery signal is transmitted and/or its neighboring beams.

2. The receiving UE transmits a response message (or message 2) to the transmitting UE in response to the discovery signal. If the receiving UE has detected and/or measured a plurality of beams on which the discovery signal is transmitted, the receiving UE may report a response message containing the measured results for each of the plurality of beams separately to the transmitting UE, using the response message resources (time and/or frequency) allocated to each of the plurality of beams. Alternatively, if the receiving UE has detected and/or measured a plurality of beams on which the discovery signal is transmitted, the receiving UE may report a response message containing all the measured results for the plurality of beams to the transmitting UE at once, using the response message resources assigned to the transmission beam with the best measured results among the response message resources (time and/or frequency) allocated to each of the plurality of beams. Alternatively, to distinguish itself from the normal discovery process and/or to avoid conflicts with resources for the transmission of response messages for the normal discovery signal from other UEs, the receiving UE may report a response message to the transmitting UE using a preconfigured and/or preassigned separate dedicated resource for the transmission of the response message.

The response message may contain at least one of the following information.
Response type (if no separate dedicated resource is configured and/or allocated): Distinguish whether it is for discovery or beam tracking
UE ID
Measurement result (e.g., RSRP)
UE status information: May include the location, direction, velocity, and/or amount of change of the receiving UE.

3. The transmitting UE may select (e.g., refine and/or adjust) its transmission beam based on the measurement results of the transmission beam received in the response message. The transmitting UE may transmit an additional message (or message 3) for reception beam tracking of the receiving UE. The additional message may be transmitted repeatedly. The additional message may consist of BRS only. Alternatively, the additional message may be in a format such as PSCCH to convey information related to the data transmission.

Alternatively, to reduce complexity, the transmission of the additional message may be omitted, and instead by triggering and/or scheduling aperiodic BRS transmission only when actual data is being transmitted, reception beam tracking of the receiving UE may be performed.

4. The transmitting UE may perform beam alignment during the discovery duration, and transmit data to the receiving UE directly according to a data transmission time in the data transmission duration and/or may perform beam refinement and/or tracking by first triggering and/or scheduling the transmission of aperiodic BRS, and then transmit data to the receiving UE.

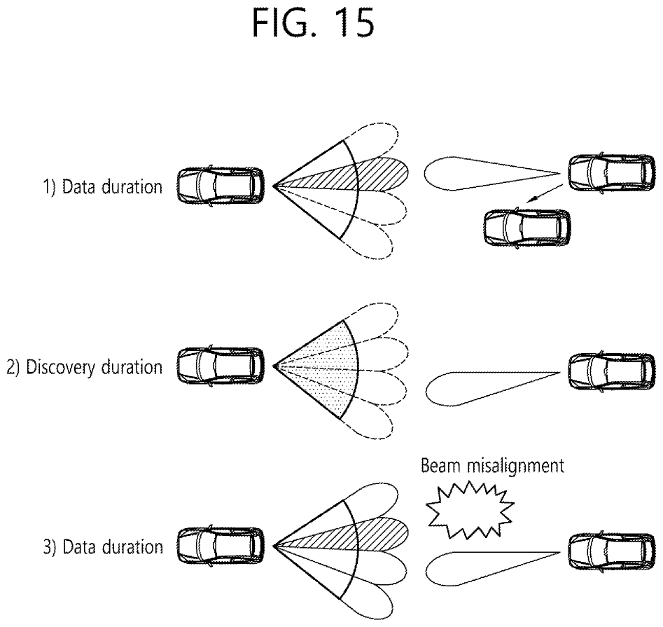

FIG. 15 shows an example where a transmission beam and a reception beam are misaligned to which the first implementation of the present disclosure is applied.

Referring to FIG. 15, the transmitting UE and the receiving UE first transmit and receive data via a narrow beam aligned with each other in a data transmission duration \textcircled{1}. The receiving UE then moves. In the discovery duration \textcircled{2}, the transmitting UE uses a wide beam to perform the discovery process. Even though the receiving UE has moved, it has moved within the coverage of the wide beam, so the transmitting UE still determines that the beams are aligned. In the subsequent data transmission duration \textcircled{3}, the transmitting UE tries to transmit and receive data using the narrow beam used in the previous data transmission duration \textcircled{1}. However, since the receiving UE has moved, beam misalignment may occur. Therefore, a transmission beam refinement is needed.

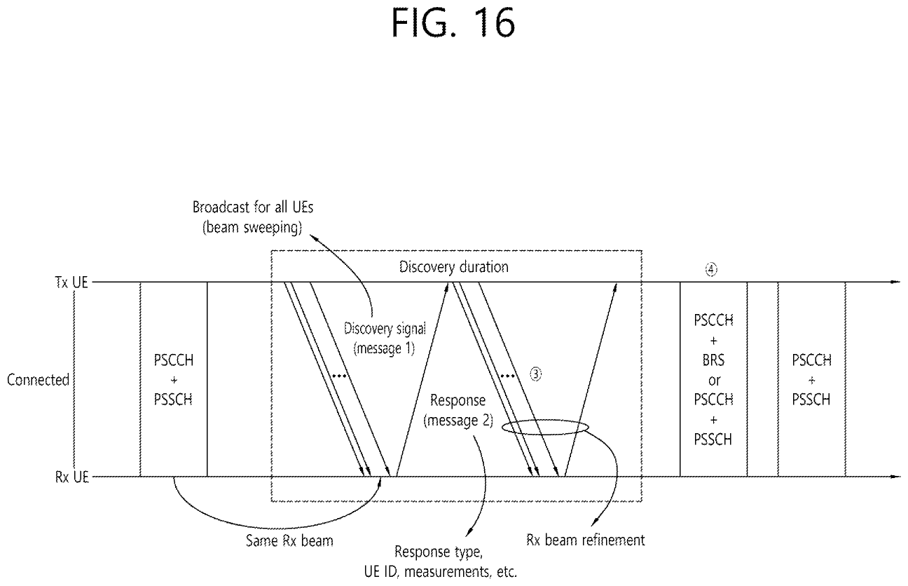

FIG. 16 shows another example of a BRS transmission to which the first implementation of the present disclosure is applied.

FIG. 16 shows beam management for a case where the beam used for transmission of the discovery signal and the beam used for transmission of the data have different widths. The operations of the transmitting UE and the receiving UE shown in FIG. 16 are as follows.

1. The transmitting UE transmits the discovery signal (or message 1) in the discovery duration in all directions by beam sweeping transmission. The receiving UE measures the discovery signal transmitted by the transmitting UE over the reception beam used to receive the data transmitted by the transmitting UE. The receiving UE may perform the measurement on all the transmission beams on which the discovery signal is transmitted. Alternatively, the receiving UE may perform the measurement only on the transmission beam that are associated (e.g., in QCL relationship) with the data transmission among all the transmission beams on which the discovery signal is transmitted and/or its neighboring beams.

2. The receiving UE transmits a response message (or message 2) to the transmitting UE in response to the discovery signal. If the receiving UE has detected and/or measured a plurality of beams on which the discovery signal is transmitted, the receiving UE may report a response message containing the measured results for each of the plurality of beams separately to the transmitting UE, using the response message resources (time and/or frequency) allocated to each of the plurality of beams. Alternatively, if the receiving UE has detected and/or measured a plurality of beams on which the discovery signal is transmitted, the receiving UE may report a response message containing all the measured results for the plurality of beams to the transmitting UE at once, using the response message resources assigned to the transmission beam with the best measured results among the response message resources (time and/or frequency) allocated to each of the plurality of beams. Alternatively, to distinguish itself from the normal discovery process and/or to avoid conflicts with resources for the transmission of response messages for the normal discovery signal from other UEs, the receiving UE may report a response message to the transmitting UE using a preconfigured and/or preassigned separate dedicated resource for the transmission of the response message.

The response message may contain at least one of the following information.
Response type (if no separate dedicated resource is configured and/or allocated): Distinguish whether it is for discovery or beam tracking
UE ID
Measurement result (e.g., RSRP)
UE status information: May include the location, direction, velocity, and/or amount of change of the receiving UE.

3. The transmitting UE may select (e.g., refine and/or adjust) its transmission beam based on the measurement results of the transmission beam received in the response message. The transmitting UE may transmit an additional message (or message 3) for reception beam tracking of the receiving UE. The additional message may be transmitted repeatedly. The additional message may consist of BRS only. Alternatively, the additional message may be in a format such as PSCCH to convey information related to the data transmission.

In this case, the transmitting UE may select a narrow beam to be included in the wide beam based on the measurement results received in the response message for transmission beam refinement. The transmitting UE may perform beam sweeping on the selected narrow beam to transmit the additional message. The receiving UE may inform the transmitting UE of the index of the best beam among the narrow beams on which the additional message is received.

Alternatively, to reduce complexity, the transmission of the additional message may be omitted, and instead by triggering and/or scheduling aperiodic BRS transmission only when actual data is being transmitted, reception beam tracking of the receiving UE may be performed. In this case, if the transmitting UE has not performed any transmission beam refinement in the discovery duration, the PSCCH may be transmitted via a wide beam.

4. The transmitting UE transmits and receives data and/or triggers and/or schedules the transmission BRS via the selected transmission beam.

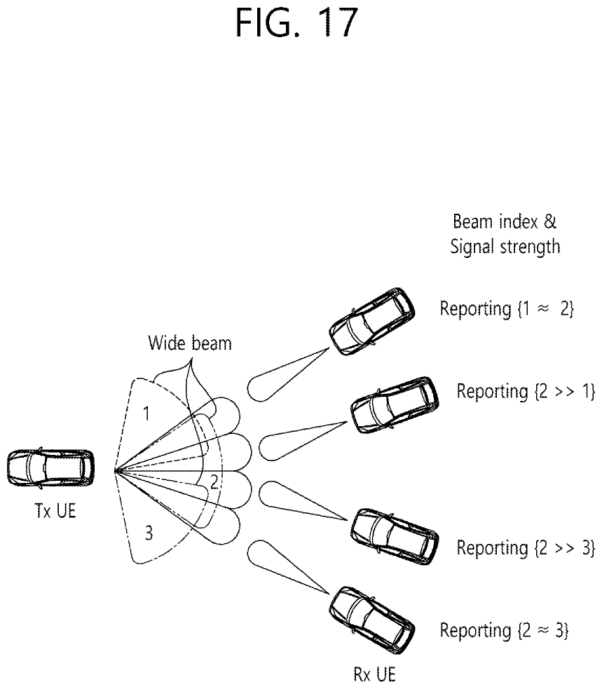

FIG. 17 shows an example of transmission beam refinement to which the first implementation of the present disclosure is applied.

FIG. 17 shows reducing the number of candidates for the narrow transmission beam during beam sweeping of the narrow transmission beam, when the beam used for transmission of the discovery signal and the beam used for data transmission have different width. Depending on the location of the receiving UE, the index of the detected wide beam and/or the measurement result (e.g., RSRP and/or Signal-to-Noise Ratio (SNR)) may be different. Therefore, the receiving UE may report the index and/or the measurement result of the detected wide beam to the transmitting UE in a response message to the discovery signal. Upon receiving this, the transmitting UE may appropriately select candidates for the narrow transmission beam for transmission beam refinement based on the reported information.

According to the first implementation of the present disclosure, by using aperiodic and/or semi-persistent reference signal configurations as a way of allocating reference signal resources for beam management, and by using discovery signals in a discovery duration to complement this, reference signal transmission and/or measurement result reporting can be minimized.

According to the first implementation of the present disclosure, in mmWave V2X communications, when multiple UEs are connected and each performs beam management, resources can be used efficiently.

According to the first implementation of the present disclosure, the overall overhead of the mmWave V2X communication system can be reduced and the communication efficiency can be increased.

2. Second Implementation

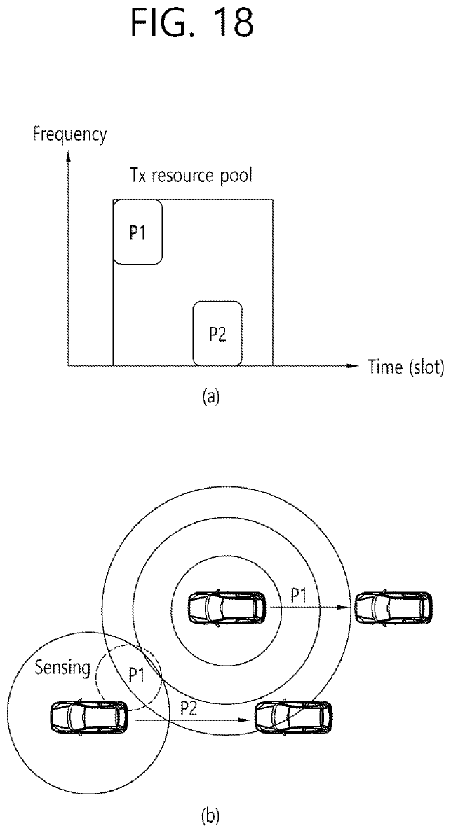

FIG. 18 shows an example of resource selection in V2X communications to the second implementation of the present disclosure is applied.

For resource allocation for sidelink communications and/or V2X communications, a UE autonomous resource selection mode may be used, in which the UE determines the transmission resources without assistance from the base station. The UE autonomous resource selection mode may be at least one of LTE transmission mode 2, LTE transmission mode 4, and/or NR resource allocation mode 2 described above. In UE autonomous resource selection mode, a UE that wishes to transmit data may select an appropriate resource to transmit data by sensing for resources within a configured transmission resource pool and/or by decoding SCI transmitted by another UE. The receiving UE may always attempt to receive on the reception resource pool except at the time of its own transmission.

Referring to FIG. 18-(a), resource P1 and resource P2 exist in the transmission resource pool. Referring to FIG. 18-(b), a vehicle that wants to transmit data performs sensing on the resource P1 and the resource P2 in the resource pool. As a result of the sensing, the resource P1 is already used by another vehicle, so the vehicle that wants to transmit data may select the resource P2 to transmit data.

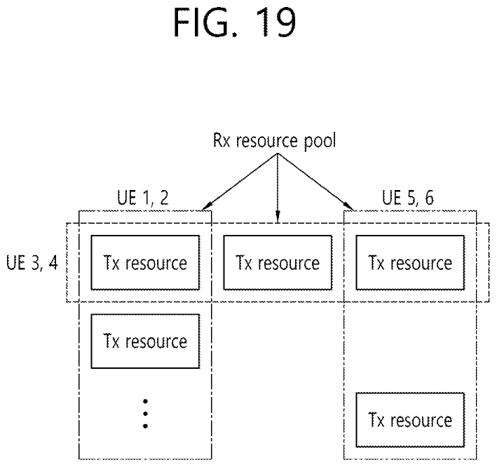

FIG. 19 shows another example of resource selection in V2X communications to the second implementation of the present disclosure is applied.

A resource pool may be common to a plurality of UEs. When each UE has data to transmit, it may select an appropriate resource to transmit data by sensing in a transmission resource pool and/or by decoding SCI transmitted by another UE. The receiving UE may attempt to receive data by attempting to blind decoding of the PSCCH for all allocated reception resource pools except at the time of its own transmission.

However, in a system that use beams such as mmWave V2X communication, especially in a situation where multiple UEs are connected and multiple UEs are sharing a resource pool, normal communication cannot occur unless the transmission and reception times are aligned with each other because the beams are not aligned. This means that without beams, a reception attempt can be made for signals transmitted in all directions at each moment, whereas with beams, a reception attempt can be made in only one beam direction at each moment. Therefore, even if a receiving UE attempts to receive during times when it is not transmitting, it may not know in advance when to set its beam in which UE direction and may set it randomly, in which case there is a very high probability that it will not receive any data. In addition, if multiple UEs do not share a resource pool, but each UE is allocated a resource pool, the size of the resource allocated to each UE may decrease as the number of connected UEs increases, and resources may be wasted because they are fixedly allocated even if they are not actually transmitting data.

In other words, when using a beam such as in mmWave V2X communication, even though the connected UEs share a pool of resources, both the transmitting and receiving UEs need to know when to transmit and receive (and/or the transmitting and receiving durations) so that they can form a beam in that direction at that time.

According to the second implementation of the present disclosure, the receiving UE may first communicate its transmission intention. Upon receiving the transmission intention, the transmitting UE may determine a transmission resource and/or transmission timing to the receiving UE based on the transmission intention. Furthermore, the transmitting UE needs to be able to know when the receiving UE has announced its transmission intention. For this, a signal for signaling the transmission intention and/or the timing of the transmission of that signal may be predetermined and/or other signals already established for transmission and reception between UEs may be used as a signal for signaling the transmission intention.

As a method of transmitting a signal to inform the transmission intention, three methods may be considered, as described below. One or more of the three methods may be used in combination.

(1) Transmitting a Transmission Intention with a HARQ ACK Response to Data Reception

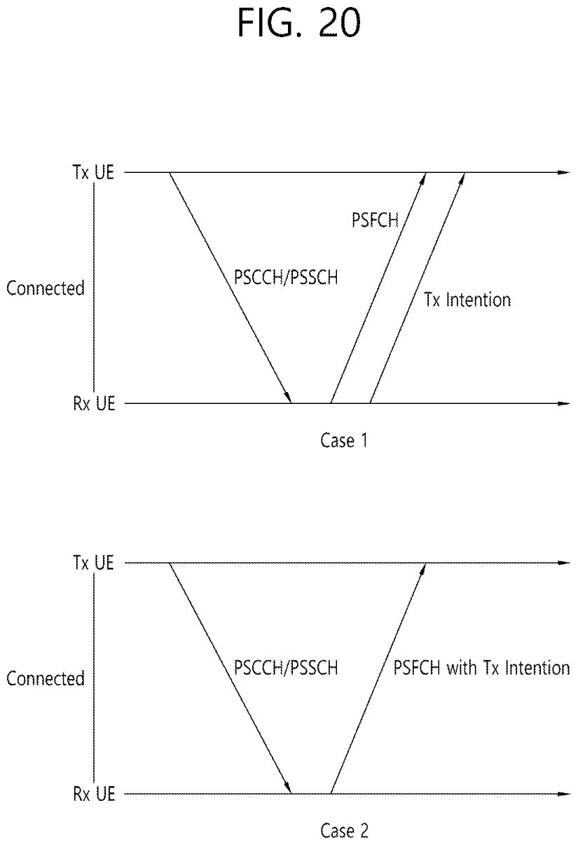

FIG. 20 shows an example of a method for informing a transmission intention according to the second implementation of the present disclosure.

If the transmitting UE is already transmitting data to the receiving UE, the timing of the transmission of the HARQ-ACK for that data may already be determined. Therefore, the receiving UE may notify the transmitting UE that it has data to transmit based on the timing of transmitting the HARQ-ACK.

Referring to Case 1 of FIG. 20, the receiving UE may first transmit a PSFCH carrying a HARQ-ACK for data to the transmitting UE and subsequently transmit a signal informing the transmission intention to the transmitting UE. The signal informing the transmission intention may occupy one or two symbols, similar to the PSFCH.

Referring to Case 2 in FIG. 20, the receiving UE may transmit a PSFCH carrying a HARQ-ACK for data to the transmitting UE, and may also transmit a signal informing the transmission intention to the transmitting UE via the PSFCH. Since the signal informing the transmission intention may be expressed in one bit, the signal informing the transmission intention may be transmitted via an additional PSFCH that is different from the PSFCH carrying the HARQ-ACK. That is, two PSFCHs may be transmitted. In this case, the frequency resource for the additional PSFCH may have an offset relative to the location of the frequency resource for the PSFCH carrying the HARQ-ACK and/or may use a dedicated frequency resource.

Alternatively, the HARQ-ACK and the transmission intention may be represented in two bits and transmitted via one PSFCH.

(2) Transmitting a Transmission Intention Via a Response Message to the Discovery Signal

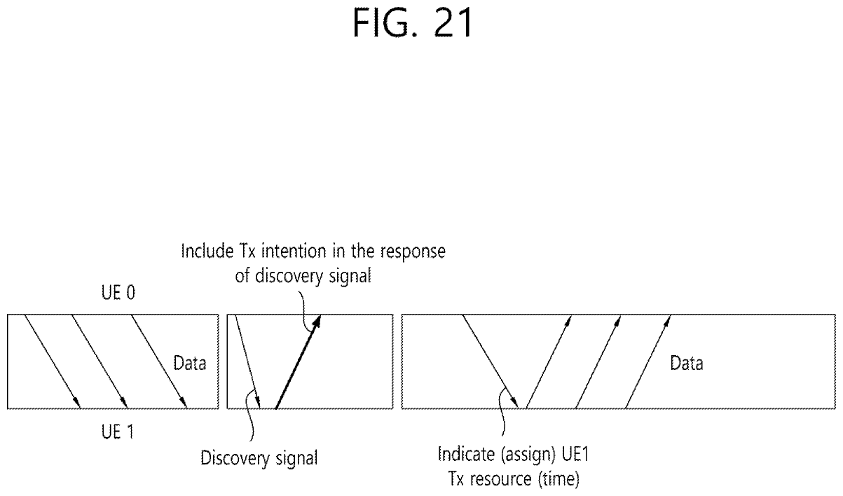

FIG. 21 shows another example of a method for informing a transmission intention according to the second implementation of the present disclosure.

In mmWave V2X communication, a discovery duration is required. The discovery signal transmitted by the other UE, even if it is already connected, may be used for beam tracking and/or beam failure recovery, and may further be used by the UE to signal its transmission intention. That is, the UE may include its ID and transmission intention in a response message to the discovery signal. Upon receiving the response message, the UE may allocate transmission resources to the receiving UE in the next data transmission duration.

Referring to FIG. 21, in the data transmission duration, UE 0 transmits data to UE 1. In the discovery duration, UE 0 transmits a discovery signal to UE 1. UE 1 includes the transmission intention of UE 1 in a response message to the discovery signal and transmits it to UE 0. Accordingly, in the next data transmission duration, UE 0 may allocate transmission resources to UE 1.

(3) Transmitting a Transmission Intention Via Semi-Persistent Scheduling

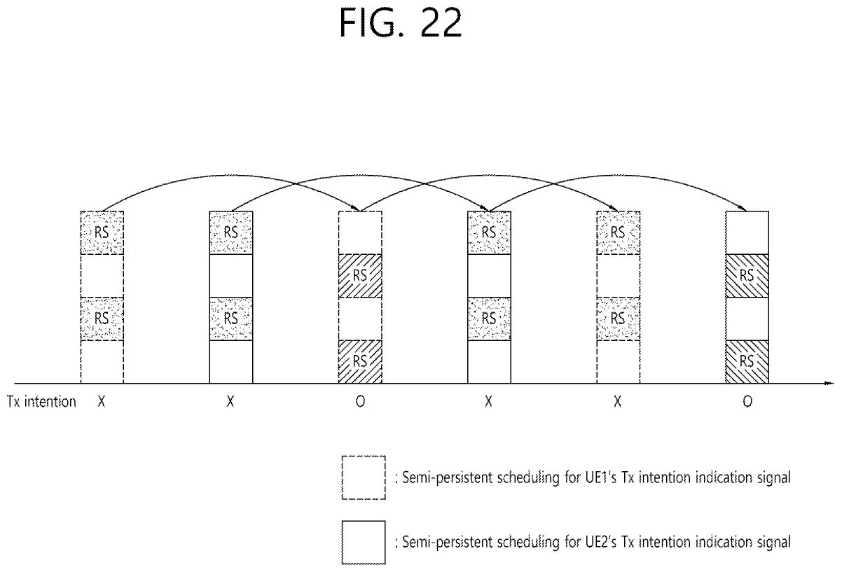

FIG. 22 shows another example of a method for informing a transmission intention according to the second implementation of the present disclosure.

A UE may periodically transmit information informing the presence or absence of data to be transmitted, using a channel and/or signal that occupies few resources (e.g., 1-2 symbols), such as a PSFCH.

FIG. 22 shows a case where each UE periodically allocates information informing the presence or absence of data to be transmitted. However, if the data transmission is mostly in one direction, the information informing the presence or absence of data to be transmitted may be set only for the receiving UE.

Further, if the information informing the presence or absence of data to be transmitted is configured via a reference signal, as shown in FIG. 22, the reference signal may be used for beam tracking and/or beam failure recovery.

According to the second implementation of the present disclosure, by first notifying the other party that there is data to be transmitted when it occurs and dynamically allocating resources based on this, resource waste can be reduced.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a transmitting User Equipment (UE) adapted to operate in a wireless communication system, the method comprising:
discovering a receiving UE during a discovery duration;
based on having data to transmit to the receiving UE, during a data duration:
i) transmitting a first Physical Sidelink Control Channel (PSCCH) that triggers transmission of a Beam management Reference Signal (BRS) to the receiving UE;
ii) transmitting the BRS to the receiving UE;
iii) transmitting a second PSCCH that schedules the data to the receiving UE; and
iv) transmitting the data to the receiving UE;
receiving a measurement result of the BRS from the receiving UE; and
adjusting a transmission beam based on the measurement result of the BRS.

2. The method of claim 1, wherein the BRS is transmitted aperiodically.

3. The method of claim 1, wherein the method further comprises, during the discovery duration:
transmitting a discovery signal to the receiving UE; and
receiving a response message to the discovery signal from the receiving UE.

4. The method of claim 3, wherein, based on the receiving UE detecting a plurality of transmission beams by receiving the discovery signal, i) the response message includes an index and a measurement result of a beam having a best measurement result among the plurality of transmission beams, and ii) the response message is received using a resource corresponding to the beam having the best measurement result.

5. The method of claim 3, wherein, based on the receiving UE detecting a plurality of transmission beams by receiving the discovery signal, i) the response message includes an index and a measurement result for each of the plurality of transmission beams, and ii) the response message is received using a resource associated with each of the plurality of transmission beams.

6. The method of claim 1, wherein the response message is received via a preconfigured frequency resource, and
wherein the preconfigured frequency resource does not conflict with a frequency resource used by another UE for the response message during a discovery process.

7. The method of claim 1, wherein the response message comprises at least one of a response type, a UE Identifier (ID), and/or a status of the receiving UE.

8. The method of claim 1, wherein the method further comprises receiving information informing presence or absence of an intention to transmit data from the receiving UE.

9. The method of claim 8, wherein the information informing presence or absence of the intention to transmit data is received in conjunction with a Hybrid Automatic Repeat Request (HARQ)-Acknowledgment (ACK) for the data and/or is received subsequent to reception of the HARQ-ACK.

10. The method of claim 9, wherein, based on the information informing presence or absence of the intention to transmit data being received in conjunction with the HARQ-ACK, the information informing presence or absence of the intention to transmit data is received via a frequency resource associated with a frequency resource for the HARQ-ACK and/or via a dedicated frequency resource.

11. The method of claim 8, wherein the information informing presence or absence of the intention to transmit data is received by being included in a response message to a discovery signal in the discovery duration.

12. The method of claim 8, wherein the information informing presence or absence of the intention to transmit data is received periodically.

13. The method of claim 1, wherein the transmitting UE is in communication with at least one of a mobile device, a network, and/or autonomous vehicles other than the transmitting UE.

14. A transmitting User Equipment (UE) adapted to operate in a wireless communication system, the transmitting UE comprising:
at least one transceiver;
at least one processor; and
at least one memory operably connectable to the at least one processor and storing instructions that, based on being executed by the at least one processor, perform operations comprising:
discovering a receiving UE during a discovery duration;
based on having data to transmit to the receiving UE, during a data duration using the at least one transceiver:
i) transmitting a first Physical Sidelink Control Channel (PSCCH) that triggers transmission of a Beam management Reference Signal (BRS) to the receiving UE;
ii) transmitting the BRS to the receiving UE;
iii) transmitting a second PSCCH that schedules the data to the receiving UE; and
iv) transmitting the data to the receiving UE;
receiving a measurement result of the BRS from the receiving UE using the at least one transceiver; and
adjusting a transmission beam of the at least one transceiver based on the measurement result of the BRS.

15.-17. (canceled)

18. A receiving User Equipment (UE) adapted to operate in a wireless communication system, the receiving UE comprising:
at least one transceiver;
at least one processor; and
at least one memory operably connectable to the at least one processor and storing instructions that, based on being executed by the at least one processor, perform operations comprising:
discovering a transmitting UE during a discovery duration;
based on having data to receive from the transmitting UE, during a data duration using the at least one transceiver:
i) receiving a first Physical Sidelink Control Channel (PSCCH) that triggers transmission of a Beam management Reference Signal (BRS) from the transmitting UE;
ii) receiving the BRS from the transmitting UE;
iii) receiving a second PSCCH that schedules the data from the transmitting UE; and
iv) receiving the data from the transmitting UE; and
transmitting a measurement result of the BRS to the transmitting UE using the at least one transceiver.

19-20. (canceled)
